(19) United States
(12) Patent Application Publication
(10) Pub. No.: US 2021/0084293 A1
(43) Pub. Date: Mar. 18, 2021

(54) METHOD AND APPARATUS FOR CODING VIDEO DATA

(71) Applicant: ALIBABA GROUP HOLDING LIMITED, George Town (KY)

(72) Inventors: Mohammed Golam SARWER, San Mateo, CA (US); Jiancong LUO, San Mateo, CA (US); Yan YE, San Mateo, CA (US)

(21) Appl. No.: 16/991,720

(22) Filed: Aug. 12, 2020

Related U.S. Application Data
(60) Provisional application No. 62/899,167, filed on Sep. 12, 2019.

(51) Int. Cl. H04N 19/107; H04N 19/184

(52) U.S. Cl. CPC H04N 19/107; H04N 19/13; H04N 19/184

(57) ABSTRACT

The present disclosure provides a computer-implemented method for encoding video. The method includes coding a bitstream including coefficient groups of a transform block, and flags that correspond respectively to the coefficient groups. Each of the coefficient groups includes one or more coefficients. The coding of the bitstream includes: after a number of context coded bins in the bitstream exceeds a threshold, coding remaining flags or coefficients in the bitstream in a bypass coding mode.

### CROSS-REFERENCE TO RELATED APPLICATIONS

This application is based upon and claims priority to U.S. Provisional Patent Application No. 62/899,167, filed Sep. 12, 2019, and entitled “METHOD AND APPARATUS FOR CODING VIDEO DATA,” the entire contents thereof are incorporated herein by reference.

### TECHNICAL FIELD

The present disclosure generally relates to video processing, and more particularly, to methods and systems for coding coefficient groups (CGs) related to a transform block (TB) and coding flags indicating the values of coefficients within the CGs.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide methods and apparatus for encoding or decoding video.

In some exemplary embodiments, a non-transitory computer-readable storage medium is provided. The non-transitory computer-readable storage medium stores a set of instructions that are executable by one or more processor of a device to cause the device to perform a method for encoding video of: coding a bitstream including coefficient groups of a transform block, and flags that correspond respectively to the coefficient groups. Each of the coefficient groups includes one or more coefficients. The coding of the bitstream includes: after a number of context coded bins in the bitstream exceeds a threshold, coding remaining flags or coefficients in the bitstream in a bypass coding mode.

In some exemplary embodiments, an apparatus is provided. The apparatus includes a memory configured to store instructions and a processor coupled to the memory and configured to execute the instructions to cause the apparatus to: code a bitstream including coefficient groups of a transform block, and flags that correspond respectively to the coefficient groups. Each of the coefficient groups includes one or more coefficients. The coding of the bitstream includes: after a number of context coded bins in the bitstream exceeds a threshold, coding remaining flags or coefficients in the bitstream in a bypass coding mode.

In some exemplary embodiments, a computer-implemented method for encoding video is provided. The method includes: coding a bitstream including coefficient groups of a transform block, and flags that correspond respectively to the coefficient groups. Each of the coefficient groups includes one or more coefficients. The coding of the bitstream includes: after a number of context coded bins in the bitstream exceeds a threshold, coding remaining flags or coefficients in the bitstream in a bypass coding mode.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1A illustrates structures of an exemplary video sequence, consistent with some embodiments of the disclosure.

FIG. 1B illustrates an exemplary transform block (TB) being divided into multiple coefficient groups (CGs), consistent with some embodiments of the disclosure.

FIG. 2 illustrates a schematic diagram of an exemplary encoder of a hybrid video coding system, consistent with some embodiments of the disclosure.

FIG. 3 illustrates a schematic diagram of an exemplary decoder of the hybrid video coding system, consistent with some embodiments of the disclosure.

FIG. 4 illustrates a block diagram of an exemplary apparatus for encoding or decoding a video, consistent with some embodiments of this disclosure.

FIG. 5 illustrates an exemplary bitstream, consistent with some embodiments of the disclosure.

FIG. 6 illustrates another exemplary bitstream, consistent with some embodiments of the disclosure.

FIG. 7 illustrates a flowchart of an exemplary process for a video encoding method, consistent with some embodiments of the disclosure.

FIG. 8 illustrates yet another exemplary bitstream, consistent with some embodiments of the disclosure.

FIG. 9 illustrates a flowchart of another exemplary process for the video encoding method, consistent with some embodiments of the disclosure.

FIG. 10 illustrates a flowchart of an exemplary process for a video decoding method, consistent with some embodiments of the disclosure.

FIG. 11 illustrates a flowchart of another exemplary process for the video decoding method, consistent with some embodiments of the disclosure.

FIG. 12 illustrates an exemplary coding syntax table, consistent with some embodiments of the disclosure.

FIG. 13 illustrates another exemplary coding syntax table, consistent with some embodiments of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium.

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

In order to achieve the same subjective quality as High Efficiency Video Coding (HEVC, also known as ITU-T H.265 and MPEG-H Part 2) using half the bandwidth, the Joint Video Experts Team (JVET), a video expert team of the ITU-T Video Coding Expert Group (ITU-T VCEG) and the ISO/IEC Moving Picture Expert Group (ISO/IEC MPEG), has been developing technologies beyond HEVC using the joint exploration model (JEM) reference software. As coding technologies were incorporated into the JEM, the JEM achieved substantially higher coding performance than HEVC. The VCEG and MPEG started the development of Versatile Video Coding (VVC, also known as ITU-T H.266, MPEG-I Part 3 and Future Video Coding), the next generation video compression standard beyond HEVC.

The VVC standard is continuing to include coding technologies that improve compression performance and is aimed at doubling the compression efficiency of HEVC standard. VVC is based on the same hybrid video coding system that has been used in modern video compression standards such as HEVC, H.264/AVC, MPEG2, H.263, etc.

In this disclosure, when encoding a picture of a video sequence, a context coding mode or a bypass coding mode can be selected based on whether a maximum number of context coded bins has been reached, to encode or decode flags and coefficients to or from the bitstream accordingly, thereby reducing the switching between two different coding modes in the coding module, and increasing the throughput of encoding or decoding.

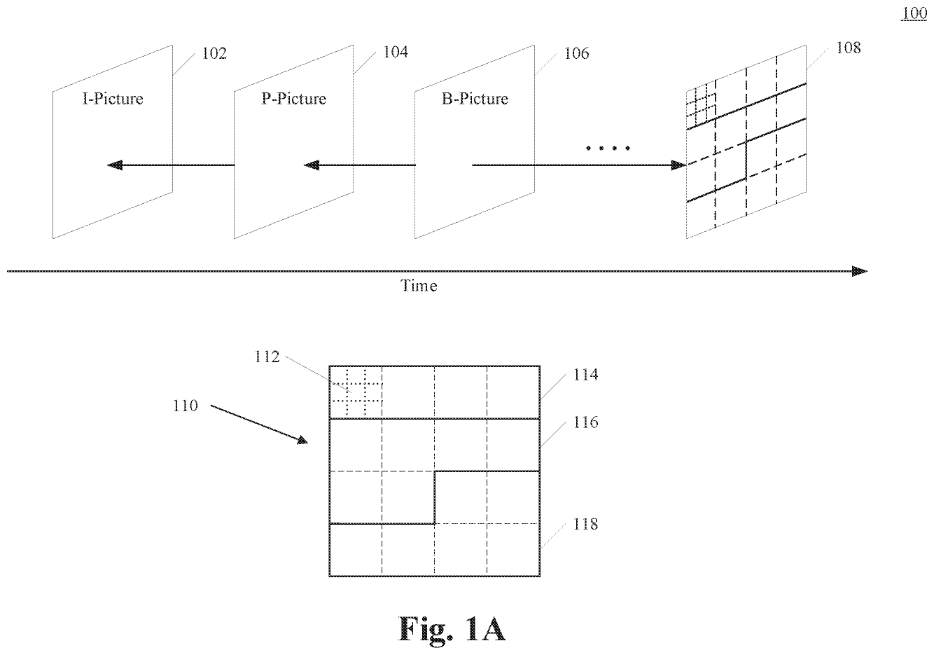

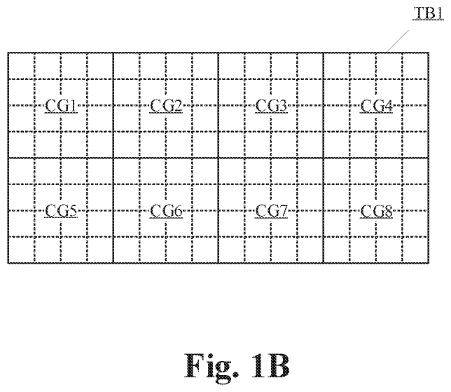

FIG. 1A illustrates structures of an exemplary video sequence, consistent with some embodiments of the disclosure. As shown in FIG. 1A, video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1A, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) includes changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture). A picture coded without referencing another picture (i.e., it is its own reference picture) can be referred to as an “I-picture.” A picture coded using a previous picture as a reference picture can be referred to as a “P-picture.” A picture coded using both a previous picture and a future picture as reference pictures (i.e., the reference is “bi-directional”) can be referred to as a “B-picture.”

For example, as shown in FIG. 1A, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may be not immediately preceding or following the picture. For example, the reference picture of picture 104 can be a picture preceding picture 102, i.e., a picture not immediately preceding picture 104. The above-described reference pictures of pictures 102-106 shown in FIG. 1A are merely examples, and not meant to limit the present disclosure.

Due to the computing complexity, in some embodiments, video codecs can split a picture into multiple basic segments, and encode or decode the picture segment by segment. That is, video codecs do not necessarily encode or decode an entire picture at one time. Such basic segments are referred to as basic processing units (“BPUs”) in this disclosure. For example, FIG. 1A also shows an exemplary structure 110 of a picture of video sequence 100 (e.g., any of pictures 102-108). For example, structure 110 may be used to divide picture 108. As shown in FIG. 1A, picture 108 is divided into 4×4 basic processing units. In some embodiments, the basic processing units can be referred to as “coding tree units” (“CTUs”) in some video coding standards (e.g., H.265/HEVC or H.266VVC), or as “macroblocks” in some video coding standards (e.g., MPEG family, H.261, H.263, or H.264/AVC). The basic processing units in FIG. 1A is for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Operations performed to a basic processing unit can be repeatedly performed to its luma and chroma components.

During multiple stages of operations in video coding, the size of the basic processing units may still be too large for processing, and thus can be further divided into segments referred to as “basic processing sub-units” in this disclosure. For example, at a mode decision stage, the encoder can further split the basic processing unit into multiple basic processing sub-units, and decide a prediction type for each individual basic processing sub-unit. As shown in FIG. 1A, basic processing unit 112 in structure 110 is further divided into 3×3 basic processing sub-units. The basic processing sub-units in FIG. 1A is for illustrative purpose only. Different basic processing units of the same picture can be divided into basic processing sub-units in different schemes.

In some embodiments, the basic processing sub-units can be referred to as “coding units” (“CUs”) in some video coding standards (e.g., H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be divided using different schemes.

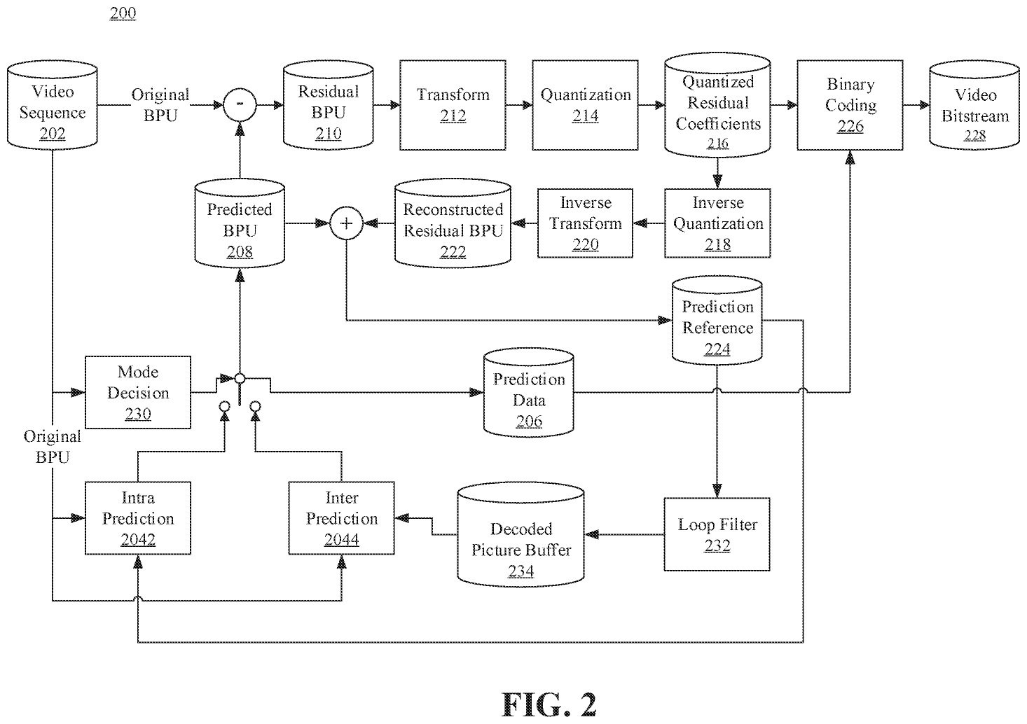

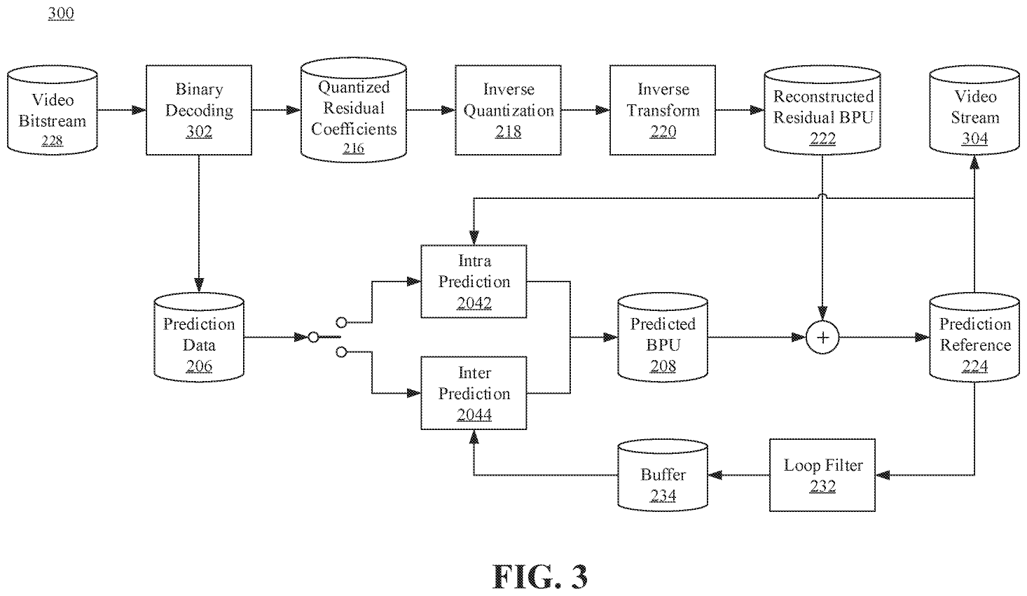

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs” in H.265/HEVC or H.266/VVC), at the level of which a prediction operation can be performed. Similarly, the encoder can further split the basic processing sub-unit into smaller segments (e.g., referred to as “transform blocks” or “TBs” in H.265/HEVC or H.266/VVC), at the level of which a transform operation can be performed. The division schemes of the same basic processing sub-unit can be different at the prediction stage and the transform stage. For example, in H.265/HEVC or H.266/VVC, the prediction blocks (PBs) and transform blocks (TBs) of the same CU can have different sizes and numbers. Operations in the mode decision stage, the prediction stage, the transform stage will be detailed in later paragraphs with examples provided in FIG. 2 and FIG. 3.

In some implementations, to provide the capability of parallel processing and error resilience to video encoding and decoding, a picture can be divided into regions for processing, such that, for a region of the picture, the encoding or decoding process can depend on no information from any other region of the picture. In other words, regions of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” Different pictures of video sequence 100 can also have different partition schemes for dividing a picture into regions.

For example, in FIG. 1A, structure 110 is divided into three regions 114, 116, and 118, the boundaries of which are shown as solid lines inside structure 110. Region 114 includes four basic processing units. Regions 116 and 118 each includes six basic processing units. It should be noted that the basic processing units, basic processing sub-units, and regions of structure 110 in FIG. 1A are only examples, and not meant to limit the present disclosure.

FIG. 1B illustrates an exemplary transform block (TB) TB1 being divided into multiple coefficient groups (CGs) CG1-CG8, consistent with some embodiments of the disclosure.

In H.265/HEVC and H.266/VVC, residual coefficients of a TB are coded with non-overlapped CGs. As shown in FIG. 1B, in some embodiments, any one of CGs (e.g., CG1-CG8) can contain the coefficients of a 4×4 block of a TB (e.g., TB1). For example, a 16×8 TB can be divided into 8 CGs. The size of CGs can be selected based on the size of the TB. When coding CGs, CGs within a TB and coefficients inside the current CG can be scanned and coded according to a predefined scan order.

FIG. 2 illustrates a block diagram of an exemplary encoder 200 of a hybrid video coding system (e.g., H.26x series), consistent with some embodiments of the disclosure. The input video is processed block by block. As discussed above, in VVC, a CTU is the largest block unit and can be as large as 128×128 luma samples (plus the corresponding chroma samples depending on the chroma format). One CTU may be further partitioned into CUs using quad-tree, binary tree, or ternary tree.

Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1A, video sequence 202 can include a set of pictures (referred to as “original pictures”) arranged in a temporal order. Similar to structure 110 in FIG. 1A, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions (e.g., regions 114-118 in FIG. 1A) of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. Generally, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture. An inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2042, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1A), it can be deemed that the matching region “moves” to the location of the original BPU as time goes by. Encoder 200 can record the direction and distance of such a motion as a “motion vector.” When multiple reference pictures are used (e.g., as picture 106 in FIG. 1A), encoder 200 can search for a matching region and determine its associated motion vector for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, motion vectors associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the motion vector) and prediction reference 224. For example, encoder 200 can move the matching region of the reference picture according to the motion vector, in which encoder 200 can predict the original BPU of the current picture. When multiple reference pictures are used (e.g., as picture 106 in FIG. 1A), encoder 200 can move the matching regions of the reference pictures according to the respective motion vectors and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction, and be unidirectional or bidirectional. Unidirectional inter predictions can use one or more reference pictures in the same temporal direction with respect to the current picture. For example, picture 104 in FIG. 1A is a unidirectional inter-predicted picture, in which the reference picture (i.e., picture 102) precedes picture 104. In uni-prediction, only one motion vector pointing to one reference picture is used to generate the prediction signal for the current block.

On the other hand, bidirectional inter predictions can use one or more reference pictures at both temporal directions with respect to the current picture. For example, picture 106 in FIG. 1A is a bidirectional inter-predicted picture, in which the reference pictures (e.g., pictures 104 and 108) are at opposite temporal directions with respect to picture 104. In bi-prediction, two motion vectors, each pointing to its own reference picture, are used to generate the prediction signal of the current block. After video bitstream 228 is generated, motion vectors and reference indices can be sent in video bitstream 228 to a decoder, to identify where the prediction signal(s) of the current block come from.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate predicted reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, in H.265/HEVC and H.266/VVC, both transform and transform skip residual coefficients are coded within non-overlapped CGs. That is, each CG may include one or more transform residual coefficients, or one or more transform skip residual coefficients.

FIG. 3 illustrates a block diagram of an exemplary decoder 300 of a hybrid video coding system (e.g., H.26x series), consistent with some embodiments of the disclosure.

Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., regions 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate predicted reference 224. In some embodiments, predicted reference 224 can be stored in a buffer (e.g., a decoded picture buffer in a computer memory). Decoder 300 can feed predicted reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO and/or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate predicted reference 224 for encoding the next encoded BPU of the encoded picture. After decoding all encoded BPUs of the encoded picture, decoder 300 can output the picture to video stream 304 for display and proceed to decode the next encoded picture in video bitstream 228.

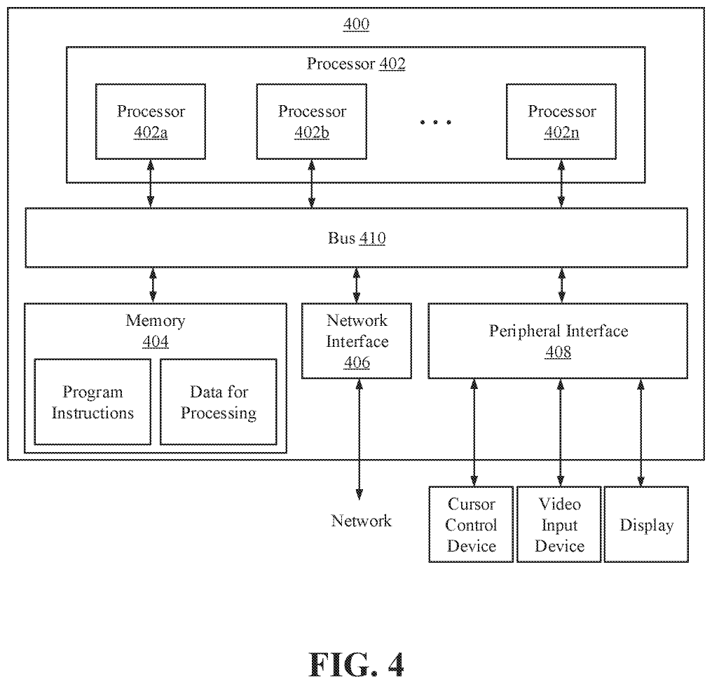

FIG. 4 is a block diagram of an exemplary apparatus 400 for encoding and/or decoding a video, according to some embodiments of this disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in encoder 200 or decoder 300) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process of encoder 200 or decoder 300) can be implemented as any combination of any software or hardware modules in apparatus 400. For example, some or all stages of process encoder 200 or decoder 300 can be implemented as one or more software modules of apparatus 400, such as program instructions that can be loaded into memory 404. For another example, some or all stages of process encoder 200 or decoder 300 can be implemented as one or more hardware modules of apparatus 400, such as a specialized data processing circuit (e.g., an FPGA, an ASIC, an NPU, or the like).

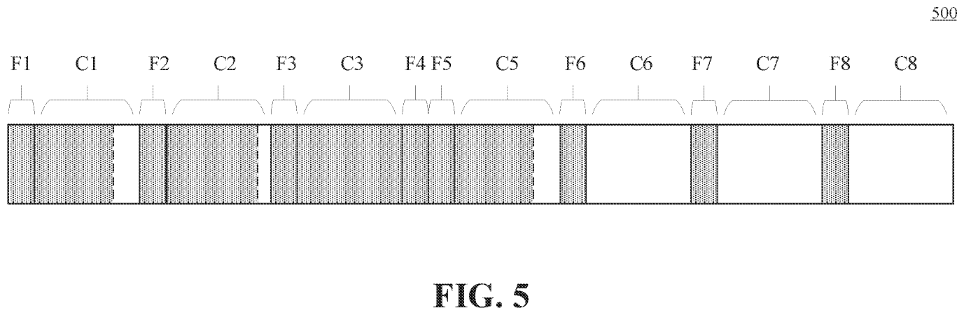

FIG. 5 illustrates an exemplary bitstream 500 of an image block, consistent with some embodiments of the disclosure. Bitstream 500 includes coded sub-block flag (CSBF) F1-F8 and coded coefficients C1-C3, C5-C8 with the corresponding CGs. In some embodiments, a CSBF can be coded for each CG to indicate whether the corresponding CG includes any non-zero coefficients. In bitstream 500, for each CG, a corresponding coded sub-block flag (e.g., flags F1-F8) is signaled at the beginning of the CG. The coded sub-block flag being 0 means all coefficients of the corresponding CG are zero. Therefore, coding of the transform coefficients of the CG can be skipped. The coded sub-block flag being 1 means that the corresponding CG includes at least one non-zero coefficient. In the example shown in FIG. 5, flag F4 is 0 and therefore it is not followed by non-zero coefficient, i.e., not followed by corresponding CG4.

In VVC, a parameter “MaxCcbs” is a threshold indicating the maximum number of context coded bins of a TB. MaxCcbs can be predefined and computed based on the TB size. In some embodiments, MaxCcbs also depends on whether a transform stage is skipped in the TB. A transform skip flag of the TB can be used to indicate whether the transform stage is skipped. For example, transform skip flag being 1 means the transform stage is skipped. Transform skip flag being 0 means the transform stage is not skipped. In different versions of VVC, the parameter MaxCcbs may be predefined and computed differently. For example, in some embodiments, if the transform skip flag indicates that the transform stage is skipped in the block, the parameter MaxCcbs can be defined and computed from the codes as follows:

MaxCcbs=2*(1<<log 2TbWidth)*(1<<log 2TbHeight),

while in some other embodiments, the parameter MaxCcbs can be defined and computed from the codes as follows:

MaxCcbs=((1<<(log 2TbWidth+log 2TbHeight))*7)>>2,

where log 2TbWidth denotes the logarithmic value of a horizontal width (“TbWidth”) of the TB, log 2TbHeight denotes the logarithmic value of a vertical width (“TbHeight”) of the TB, and MaxCcbs denotes the computed threshold. It is contemplated that the parameter MaxCcbs may also be defined and computed using other equations, and the equations described above are for examples only and not meant to limit the present disclosure.

On the other hand, if the transform skip flag indicates that the transform stage is not skipped in the block, the parameter MaxCcbs can be defined and computed from the codes as follows:

MaxCcbs=((1<<(log 2TbWidth+log 2TbHeight))*7)>>2

In some embodiments, the coded sub-block flag is context coded regardless whether the number of context coded bins reached the maximum limit for the TB. In bitstream 500, the portions filled with the pattern represent context coded bins, and the rest portions represent the bypass coded bins.

Because the coded sub-block flag is context coded, as shown in FIG. 5, even after the context coded bins reach the maximum limit, a module for binary coding stage 226 (e.g., a CABAC module) has to switch between bypass coding and context coding, which impacts and reduces the throughput of decoder 300.

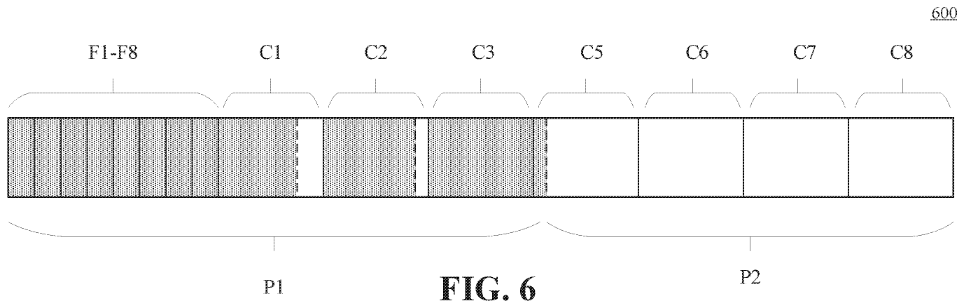

In some embodiments of the present disclosure, video encoding methods are provided to avoid context/bypass switching after reaching the maximum number of context coded bins of the block. FIG. 6 illustrates an exemplary bitstream 600 generated by using the disclosed video encoding method, consistent with some embodiments of the disclosure. As shown in FIG. 6, in some embodiments, compared to the bitstream 500 (FIG. 5), coded sub-block flags F1-F8 of bitstream 600 are repositioned at the beginning of the transform-skip residual block for transform-skip case. In case of transform residual block, coded sub-block flags F1-F8 can also be coded after the coding of the last significant position. The disclosed methods can ensure that after the number of context coded bins exceeds the threshold, remaining bins of the residual block are bypass coded. As shown in FIG. 6, after the number of context coded bins exceeds the threshold (e.g., at portion P2), encoder 200 processes bypass coding bins and coefficients C5-C8 are bypass coded.

Thus, as shown in bitstream 600, the encoder can signal flags F1-F8 at a beginning of bitstream 600, and coefficient bits of CGs (e.g., coefficients C1-C3 and C5) can be context coded and/or bypass coded within portion P1, where the number of context coded bins is within the threshold. In portion P2, where the number of context coded bins exceeds the predefined threshold, remaining coefficient bits of CGs (e.g., coefficients C6-C8) are bypass coded.

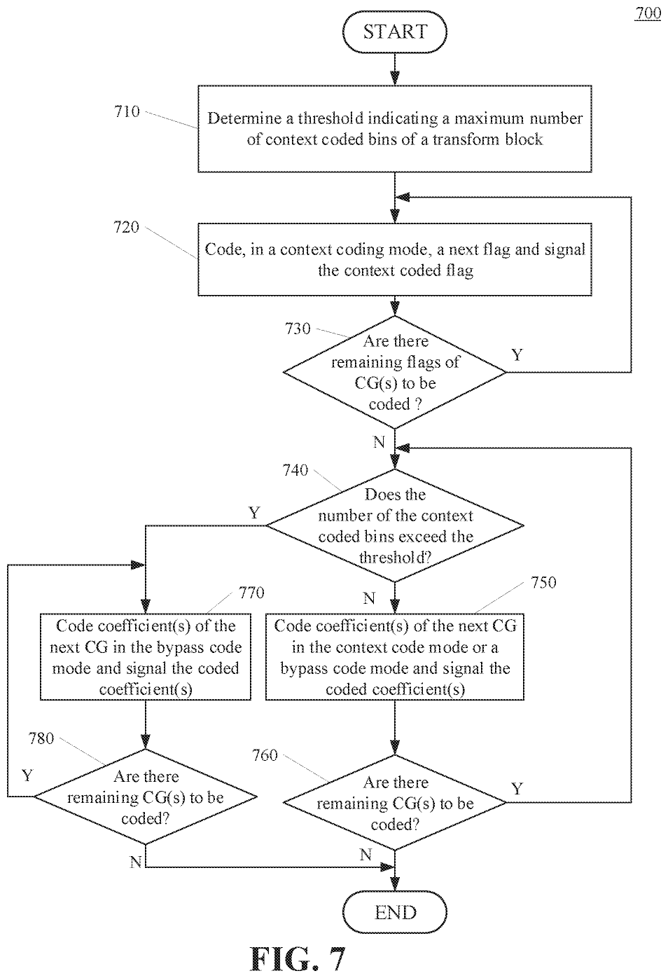

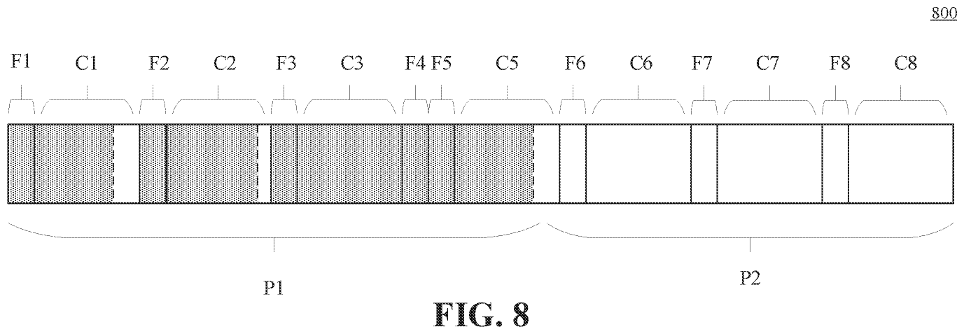

FIG. 7 illustrates a flowchart of an exemplary video encoding method 700, consistent with some embodiments of the disclosure. In some embodiments, video encoding method 700 can be performed by an encoder (e.g., encoder 200 in FIG. 2) to generate bitstream 600 shown in FIG. 6. For example, the encoder can be implemented as one or more software or hardware components of an apparatus (e.g., apparatus 400 in FIG. 4) for encoding or transcoding a video sequence (e.g., video sequence 202 in FIG. 2) to generate the bitstream (e.g., video bitstream 228 in FIG. 2) for the video sequence. For example, a processor (e.g., processor 402 in FIG. 4) can perform video encoding method 700.

Referring to video encoding method 700, at step 710, the encoder determines a threshold (e.g., a parameter MaxCcbs) indicating a maximum number of context coded bins of a TB. As discussed above, the threshold may depend on whether the transform stage is skipped in the TB, and be determined according to a size of the TB. In some embodiments, the threshold can further be determined according to a number of the CGs in the TB, or a number of the flags to be coded in the bitstream (e.g., bitstream 600 in FIG. 6).

In steps 720-780, the encoder codes the bitstream including coefficient groups of a transform block and flags that correspond respectively to the coefficient groups. At step 720, the encoder codes, in a context coding mode, a next flag that correspond to the next CG in the TB and signals the context coded flags (e.g., flags F1-F8 in FIG. 6) at a beginning of a bitstream (e.g., bitstream 600 in FIG. 6). Compared to bitstream 500 in FIG. 5, in bitstream 600 in FIG. 6, context coded flags F1-F8 are repositioned within portion P1, where the number of context coded bins is within the threshold. Accordingly, it is guaranteed that no context coded flags are positioned after the number of context coded bins exceeds the threshold (e.g., at portion P2). In some embodiments, at step 720, in response to the number of the context coded bins exceeding the threshold, the encoder may also code and signal, in the bitstream, one or more remaining flags in the bypass coding mode following the flags that are coded in the context coding mode.

At step 730, the encoder determines whether there are remaining flags of CG(s) to be coded. If there are remaining flags of CG(s) (step 730—yes), the encoder repeats steps 720 and 730. When all flags are coded in the bitstream (step 730—no), the encoder performs step 740. At step 740, the encoder determines whether the number of context coded bins exceeds the threshold.

In response to a determination that the number of the context coded bins is within the threshold (step 740—no), the encoder performs step 750 and codes the coefficients in one or more context coded bins or bypass coded bins. Within this module, the encoder may check the availability of the remaining number of context coded bins and the coefficients can be codec as either context coded or bypass coded based on the availability of the remaining number of context coded bins. That is, the encoder signals, in the bitstream, the coefficient groups having coefficients coded in the context coding mode or in the bypass coding mode in one or more context coded bins or bypass coded bins after signaling the flags in the bitstream. As explained in above paragraphs, the bypass coding mode can be selected for specific bins in order to speed up the coding process even before the number of the context coded bins reaches the threshold.

After the coefficients within the corresponding CG are coded in step 750, at step 760, the encoder determines whether there are remaining CG(s) having coefficients to be coded. If there are remaining CG(s) (step 760—yes), the encoder repeats step 740. When all coefficients in CG(s) are coded in the bitstream (step 760—no), the coding of the bitstream is completed.

In response to a determination that the number of the context coded bins exceeds the threshold (step 740—yes), the encoder performs steps 770 and 780. At step 770, the encoder codes the coefficients in one or more bypass coded bins. That is, the encoder codes and signals the remaining coefficients in the bypass coding mode after the number of the context coded bins exceeds the threshold. At step 780, similar to step 760, the encoder determines whether there are remaining CG(s) having coefficients to be coded. If there are remaining CG(s) (step 780—yes), the encoder repeats steps 770 and 780 for coding coefficients of the next CG in the bypass coding mode. If all CG(s) are coded in the bitstream (step 780—no), the coding of the bitstream is completed.

In some embodiments, in steps 740 to 780, the encoder can skip coding the coefficients within a CG, in response to the corresponding flag indicating that the coefficients within the CG are zero (e.g., the value of the corresponding flag being 0). That is, if a current CG has no non-zero coefficient, the encoder can bypass the coding of the current CG, and continue to code the next CG having non-zero coefficient(s). Referring again to FIG. 6, each of flags F1-F8 indicates whether the corresponding CG includes at least one non-zero coefficient. Because flag F4 being 0 indicates that there is no non-zero coefficient within the corresponding CG, after coding coefficients C3, the encoder codes coefficients C5 corresponding to next flag F5 being 1, which indicates that the corresponding CG includes at least one non-zero coefficient.

In some other embodiments, before coding each flag, a module for binary coding stage 226 (e.g., the CABAC module) checks and determining whether the number of the context coded bins exceeds the threshold. FIG. 8 illustrates an exemplary bitstream 800 of a residual block generated by using the disclosed video encoding method, consistent with some embodiments of the disclosure. In bitstream 800, the coded sub-block flag (CSBF) F-F8 and their corresponding CGs are position in the same as those in bitstream 500 (FIG. 5). However, as explained below, bitstream 800 is coded differently from bitstream 500.

As shown in FIG. 8, if the number of context coded bins is within the threshold, the current flag is context coded. Otherwise, the current flag is bypass coded. In this way, before the number of context coded bins exceeds the threshold, the flags (e.g., flags F1-F5 in portion P1) are context coded. On the other hand, after the number of context coded bins exceeds the threshold, the remaining flags (e.g., flags F6-F8 in portion P2) are bypass coded.

In addition, before the number of context coded bins exceeds the threshold, the coefficient bits of CGs (e.g., coefficients C1-C5 in portion P1) can be coded in the context coding mode or in the bypass coding mode. On the other hand, after the number of context coded bins exceeds the threshold, similar to the remaining flags, the remaining coefficient bits of CGs (e.g., coefficients C6-C8 in portion P2) are also coded in the bypass coding mode.

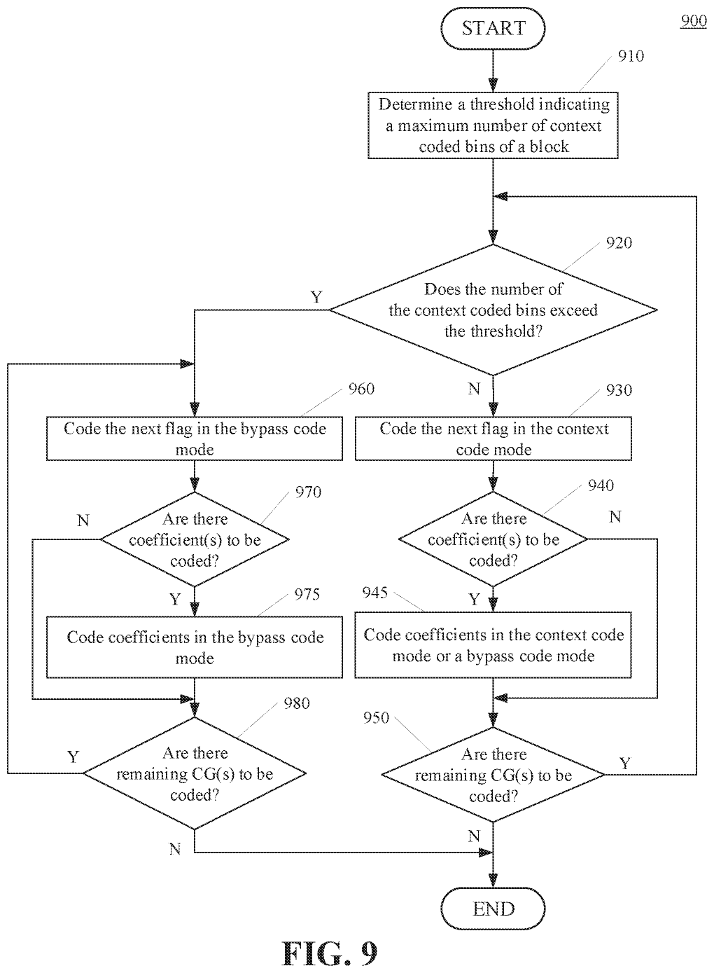

FIG. 9 illustrates a flowchart of an exemplary video encoding method 900, consistent with some embodiments of the disclosure. Similar to video encoding method 700 in FIG. 7, video encoding method 900 can also be performed by an encoder (e.g., encoder 200 in FIG. 2). For example, the encoder can be implemented as one or more software or hardware components of an apparatus (e.g., apparatus 400 in FIG. 4) for encoding or transcoding a video sequence (e.g., video sequence 202 in FIG. 2) to generate the bitstream (e.g., video bitstream 228 in FIG. 2) for the video sequence. For example, a processor (e.g., processor 402 in FIG. 4) can perform video encoding method 900 to generate bitstream 800 shown in FIG. 8.

Referring to video encoding method 900, at step 910, the encoder determines a threshold (e.g., a parameter MaxCcbs) indicating a maximum number of context coded bins of a TB. Detailed operations of step 910 are similar to those of step 710 and thus would not be repeated herein for the sake of brevity. Similar to encoding method 700 in FIG. 7, in steps 920-980, the encoder codes a bitstream including coefficient groups of a transform block and flags that correspond respectively to the coefficient groups. Each of the coefficient groups includes one or more coefficients.

At step 920, the encoder determines, before coding a flag in the bitstream, whether a number of context coded bins exceeds the threshold. In response to a determination that the number of the context coded bins is equal to or below the threshold (i.e., within the threshold) (step 920—no), the encoder performs steps 930 to 950, which corresponds to the coding of portion P1 in bitstream 800 in FIG. 8.

At step 930, the encoder codes, in the context coding mode, a next flag that correspond to the next CG. At step 940, the encoder determines whether the flag indicates that the corresponding coefficient group includes coefficient(s) to be coded in the CG. In response to a flag indicates that the corresponding coefficient group includes at least one non-zero coefficient (step 940—yes), in step 945, the encoder codes, in the context coding mode or the bypass coding mode, coefficients in one or more context coded bins or bypass coded bins. That is, in steps 940 and 945, the encoder signals, in the bitstream, each of the coefficient groups following the corresponding flag. Similar to the embodiments in FIG. 7, the bypass coding mode can be selected in step 945 for specific bins in order to speed up the coding process even though the number of the context coded bins is within the threshold.

On the other hand, in response to a flag indicating coefficients within the corresponding CG being equal to zero (step 940—no), the encoder skips step 945. Referring again to FIG. 8, in the generated bitstream 800, since flag F4 being 0 indicates that the corresponding CG does not include non-zero coefficient, after coding flag F4, the encoder skips step 945. That is, the encoder bypasses the coding of zero coefficients of the CG and codes the next flag F5 following flag F4. Flags F1-F3 and F5-F8 being 1 indicates that the corresponding CG includes at least one non-zero coefficient. After coding each of flags F1-F3 and F5-F8, the encoder codes corresponding coefficients (e.g., one of coefficients C1-C3 and C5-C8) following the coded flag F1-F3 and F5-F8.

At step 950, the encoder determines whether there are remaining flags and coefficients to be coded. If there are remaining CG(s) (step 950—yes), the encoder repeats step 920 for coding the next CG. If all CG(s) to be coded are coded in the bitstream (step 950—no), the coding of the bitstream is completed.

During this iterative process of coding CGs, in response to a determination that the number of the context coded bins exceeds the threshold (step 920—yes), the encoder performs steps 960 to 980, which corresponds to the coding of portion P2 in bitstream 800 in FIG. 8. At step 960, the encoder codes, in the bypass coding mode, the next flag that corresponds to the next CG. At step 970, the encoder determines whether the flag indicates that there are coefficient(s) to be coded in the CG.

In response to a flag indicating that the corresponding coefficient group includes at least one non-zero coefficient (step 970—yes), in step 975, the encoder codes, in the bypass coding mode, coefficients in one or more bypass coded bins. That is, in steps 970 and 975, the encoder also signals, in the bitstream, each of the coefficient groups following the corresponding flag. On the other hand, in response to a flag indicating coefficients within the corresponding CG being equal to zero (step 970—no), the encoder skips step 975. Compared to the context coded flag and coefficients in steps 930 and 945, in steps 960 and 975, the flag and corresponding coefficients are both coded in the bypass coding mode into the bitstream.

Referring again to FIG. 8, in the generated bitstream 800, flags F1-F5 in portion P1 are context coded, as the number of context coded bins is within the threshold. Flags F6-F8 and coefficients C6-C8 in portion P2 are bypass coded, as the number of context coded bins exceeds the threshold. Accordingly, it is guaranteed that no context coded flags or coefficients are positioned in the bitstream, after the number of context coded bins exceeds the threshold (e.g., at portion P2).

Referring back to FIG. 9, at step 980, similar to step 950, the encoder determines whether there are remaining CG(s) having flags or coefficients to be coded. If there are remaining CG(s) (step 980—yes), the encoder repeats steps 960 to 980 for coding the next CG in the bypass coding mode. If all CG(s) are coded in the bitstream (step 980—no), the coding of the bitstream is completed.

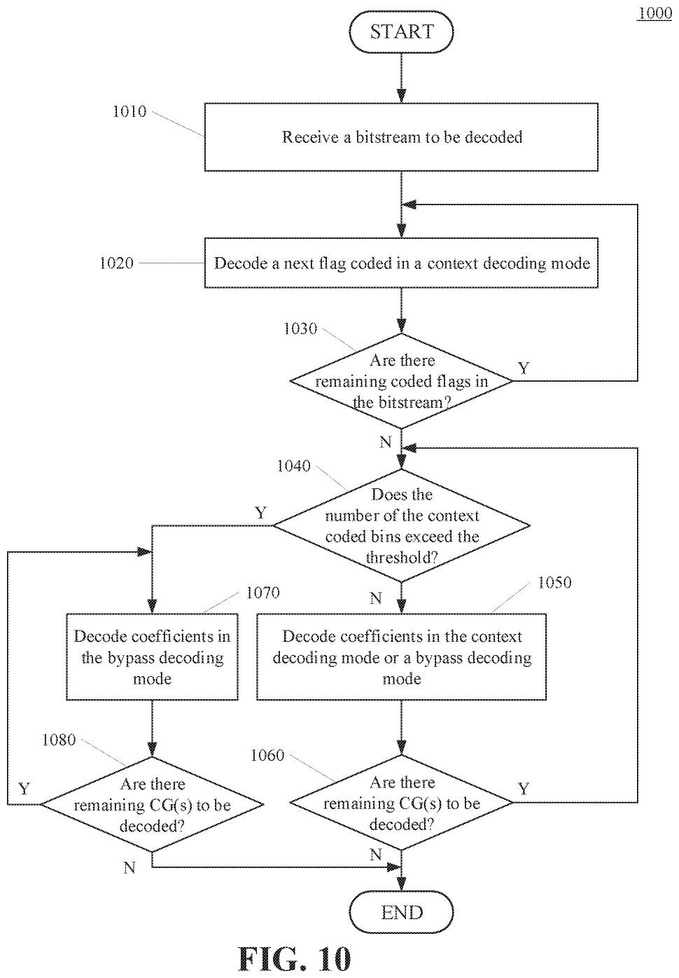

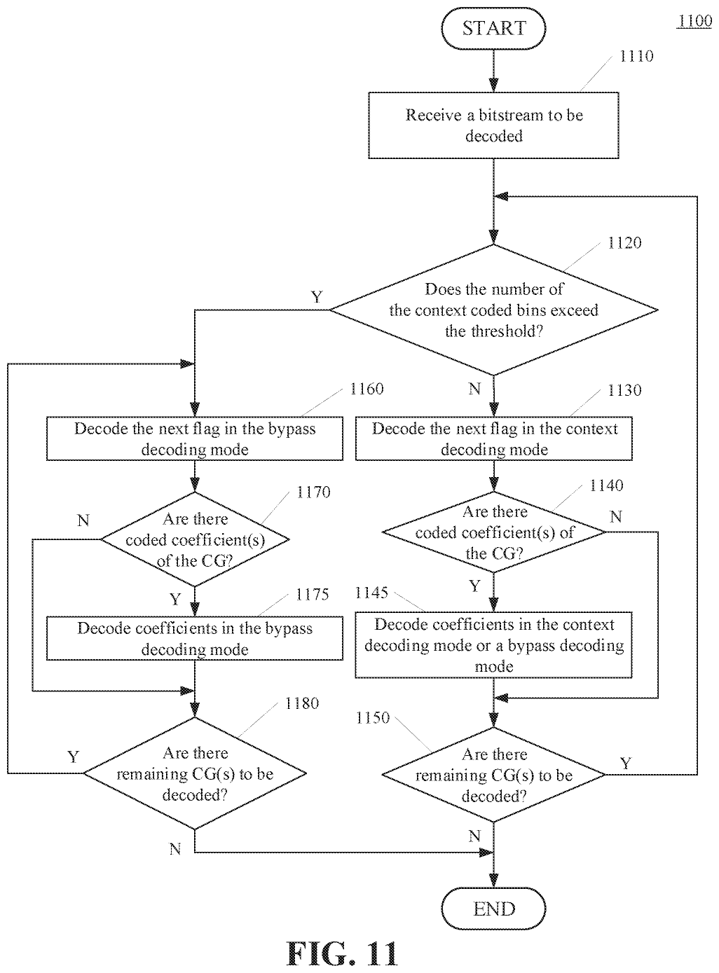

As explained above, bitstreams generated by encoder 200 using video encoding methods 700 or 900 can be decoded by decoder 300 by an inverse operation. FIG. 10 is an exemplary video decoding method 1000 corresponding to video encoding method 700 in FIG. 7, consistent with some embodiments of the disclosure. FIG. 11 is an exemplary video decoding method 1100 corresponding to video encoding method 900 in FIG. 9, consistent with some embodiments of the disclosure.

In some embodiments, video decoding methods 1000 and 1100 can be performed by a decoder (e.g., decoder 300 in FIG. 3) to respectively decode bitstream 600 in FIG. 6 and bitstream 800 in FIG. 8. For example, the decoder can be implemented as one or more software or hardware components of an apparatus (e.g., apparatus 400 in FIG. 4) for decoding the bitstream (e.g., video bitstream 228 in FIG. 3) to reconstruct a video stream (e.g., video stream 304 in FIG. 3) of the bitstream. For example, a processor (e.g., processor 402 in FIG. 4) can perform video decoding methods 1000 and 1100.

Referring to FIG. 10, in video decoding method 1000, at step 1010, the decoder receives a bitstream (e.g., video bitstream 600 in FIG. 6) to be decoded. The bitstream includes coefficient groups of a transform block, and coded flags that correspond respectively to the coefficient groups. In steps 1020 to 1080, the decoder decodes the bitstream to obtain one or more residual coefficients. After obtaining residual coefficients, the decoder reconstructs, based on the residual coefficients, the video stream corresponding to the bitstream.

At step 1020, the decoder decodes, in a context decoding mode, a next flag. Particularly, the context decoding mode can be used for decoding context coded bins.

At step 1030, the decoder determines whether there are remaining coded flag(s) in the bitstream. If there are remaining coded flag(s) (step 1030—yes), the decoder repeats steps 1020 and 1030. Accordingly, the decoder decodes context coded flags in a context decoding mode at a beginning of the bitstream. In some embodiments, in response to the number of the context coded bins being equal to or smaller than the threshold, the decoder decodes, in the context decoding mode, the flags in the bitstream. In response to the number of the context coded bins exceeding the threshold, the decoder decodes, in a bypass decoding mode, the remaining coded flags, which follows the context coded flags in the bitstream. When all flags are decoded in the bitstream (step 1030—no), the decoder performs steps 1040-1080 to decode the CGs. The coefficients in the CGs are decoded in the context decoding mode or in the bypass decoding mode.

At step 1040, the decoder determines whether the number of context coded bins exceeds the threshold. In response to a determination that the number of the context coded bins is below or equal to the threshold (step 1040—no), the decoder performs steps 1050 and 1060. At step 1050, the decoder decodes the coefficients coded in one or more context coded bins or bypass coded bins. That is, the decoder decodes, in the context decoding mode or the bypass decoding mode, the coefficients following the coded flags in the bitstream, in which the bypass decoding mode can be selected for decoding bypass coded bins. The context decoding mode and the bypass decoding mode correspond respectively to the context coding mode and the bypass coding mode at the encoder side. That is, for context decoding mode, the probability model of the bin to be used for decoding is selected by the “context,” while for the bypass decoding mode, bins are decoded using a fixed probability.

After the coefficients within the corresponding CG are decoded, at step 1060, the decoder determines whether there are remaining CG(s) having coefficients to be decoded. If there are remaining CG(s) (step 1060—yes), the encoder repeats step 1040. When all coefficients in CG(s) are decoded (step 1060—no), the decoding of the bitstream is completed.

In response to a determination that the number of the context coded bins exceeds the threshold (step 1040—yes), the decoder performs steps 1070 and 1080, in order to decode remaining flags or coefficients in the bitstream in a bypass decoding mode. At step 1070, the decoder decodes one or more remaining coefficients coded in one or more bypass coded bins. That is, the decoder decodes, in the bypass decoding mode, the remaining coefficients after the number of the context coded bins exceeds the threshold. At step 1080, similar to step 1060, the decoder determines whether there are remaining CG(s) having coefficients to be decoded. If there are remaining CG(s) (step 1080—yes), the decoder repeats steps 1070 and 1080 for decoding coefficients of the next CG in the bypass decoding mode. If all CG(s) are decoded (step 1080—no), the decoding of the bitstream is completed. That is, the coded flags and the coded coefficients in the bitstream are decoded to obtain residual coefficients for later usage. For example, the decoder may reconstruct a video stream (e.g., video stream 304 in FIG. 3) corresponding to the bitstream (e.g., video bitstream 228 in FIG. 3) based on the residual coefficients.

Referring to FIG. 11, in video decoding method 1100, at step 1110, the decoder receives a bitstream (e.g., video bitstream 800 in FIG. 8) to be decoded. In the bitstream, each of the coefficient groups immediately follows, in the bitstream, by the corresponding flag. In steps 1120-1180, the decoder decodes the flags and the CGs in an order. At step 1120, before decoding a flag in the bitstream, the decoder determines whether the number of context coded bins exceeds the threshold. In response to a determination that the number of the context coded bins is equal to or below the threshold (i.e., within the threshold) (step 1020—no), the decoder performs steps 1130 to 1150, which corresponds to the decoding of portion P1 in bitstream 800 in FIG. 8.

At step 1130, the decoder decodes, in the context decoding mode, a next flag that correspond to the next CG. At step 1140, the decoder determines whether the next CG includes at least one non-zero coefficient to be decoded, based on a value of the corresponding flag. In response to a flag indicates that there are coded coefficients following the flag (step 1140—yes), in step 1145, the decoder decodes, in the context decoding mode or the bypass decoding mode, coefficients in one or more context coded bins or bypass coded bins. Similar to the embodiments in FIG. 10, the bypass decoding mode can be selected in step 1145 for decoding bypass coded bins.

On the other hand, in response to a flag indicating that the coefficients within the corresponding CG are equal to zero so no coded coefficients follow the current flag (step 1140 —no), the decoder skips step 1145 that performs decoding the coefficients within the corresponding CG. Referring again to FIG. 8, in bitstream 800 to be decoded, since flag F4 being 0 indicates that no coefficients within the corresponding CG are coded, the decoder skips step 1145, and decodes the next flag F5 following flag F4.

Referring again to FIG. 11, at step 1150, the decoder determines whether there are remaining CG(s) having flags or coefficients to be decoded. If there are remaining CG(s) (step 1150—yes), the decoder repeats step 1120 for decoding the next CG. If all CG(s) are decoded in the bitstream (step 1150—no), the decoding of the bitstream is completed.

On the other hand, in response to a determination that the number of the context coded bins exceeds the threshold (step 1120—yes), the decoder performs steps 1160 to 1180, which corresponds to the decoding of portion P2 in bitstream 800 in FIG. 8. At step 1160, the decoder decodes, in the bypass decoding mode, the next flag that correspond to the next CG. At step 1170, the decoder determines whether the next CG includes at least one non-zero coefficient to be decoded, based on a value of the corresponding flag.

In response to a flag indicates that there are coefficient(s) to be decoded following the flag (step 1170—yes), in step 1175, the decoder decodes, in the bypass decoding mode, coefficients in one or more bypass coded bins. On the other hand, in response to a flag indicating that no coded coefficients following the flag (step 1170—no), the decoder skips step 1175. Compared to steps 1130 and 1145, in steps 1160 and 1175, the flag and corresponding coefficients are both decoded using the bypass decoding mode.

At step 1180, similar to step 1150, the decoder determines whether there are remaining CG(s) having flags or coefficients to be decoded. If there are remaining CG(s) (step 1180—yes), the decoder repeats steps 1160 to 1180 for decoding the next CG using the bypass decoding mode. If all CG(s) are decoded (step 1180—no), the coding of the bitstream is completed.

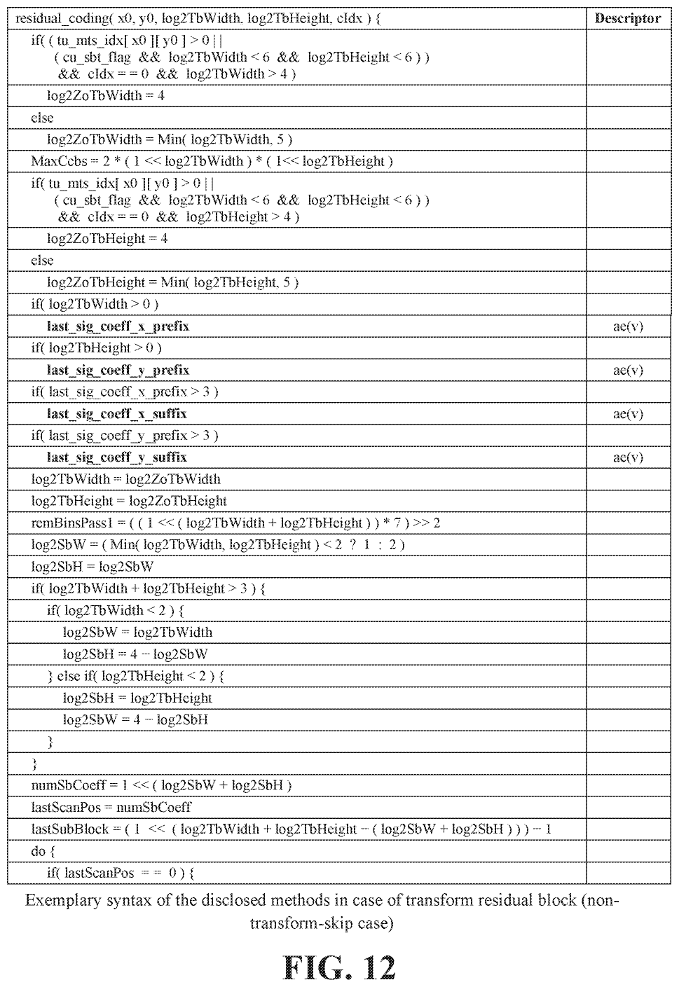

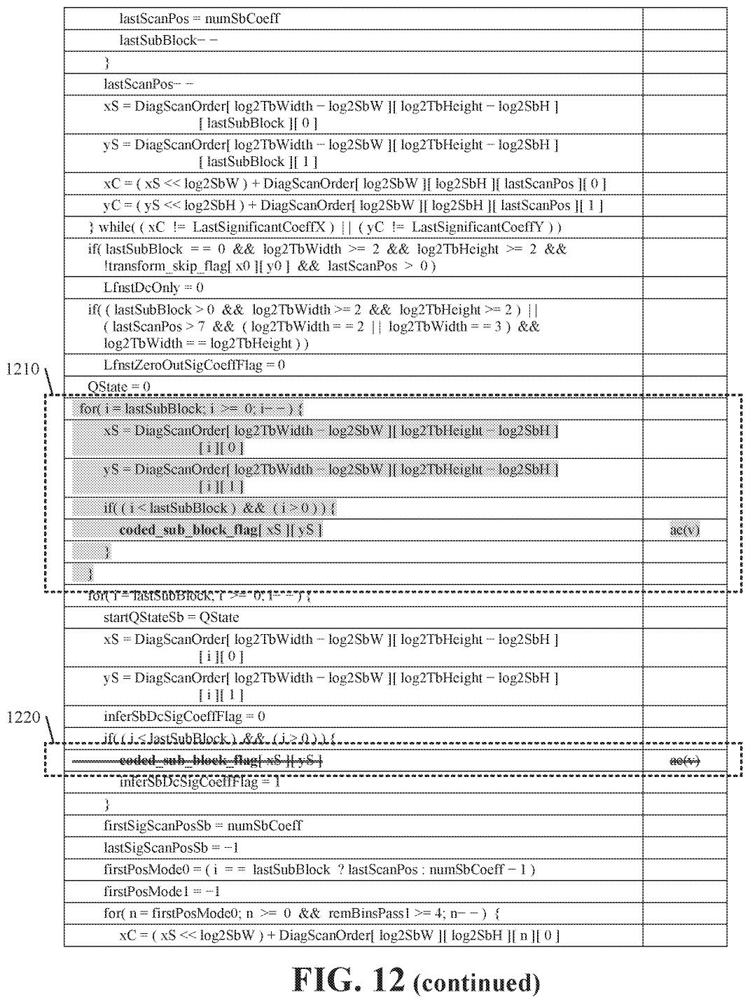

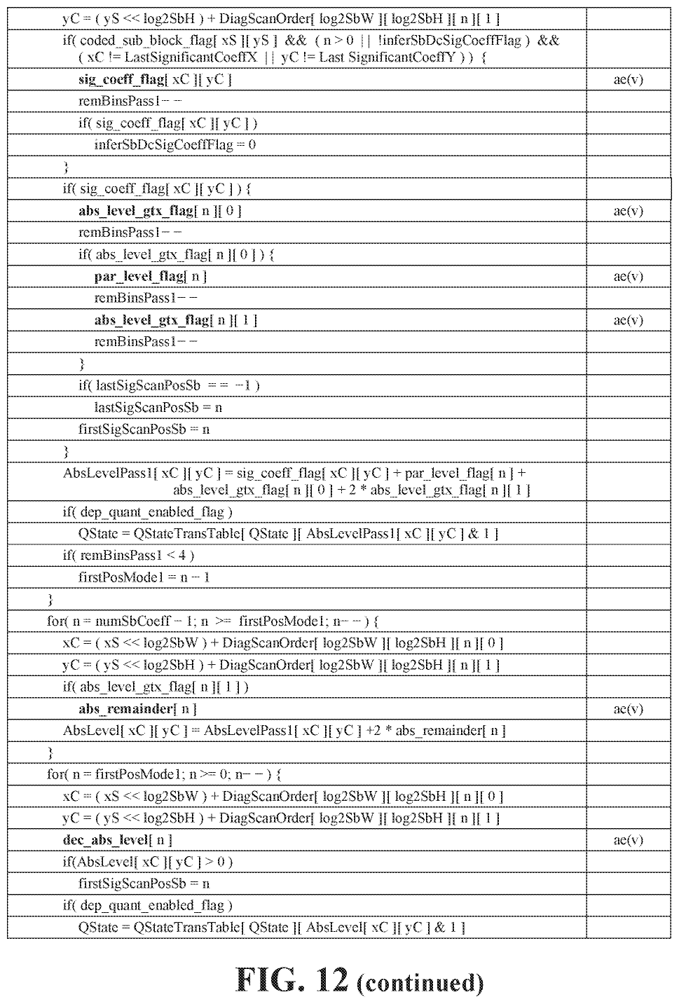

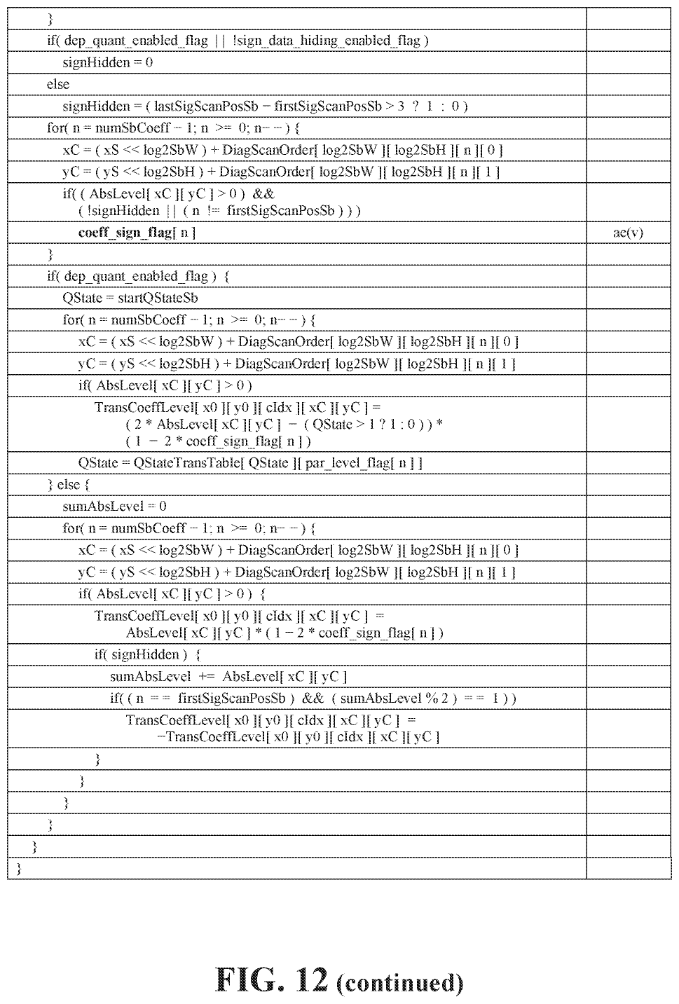

FIG. 12 illustrates an exemplary coding syntax table of the proposed method in case of transform residual block (e.g., non-transform-skip case), consistent with some embodiments of the disclosure. Particularly, the table in FIG. 12 shows a residual coding syntax (e.g., residual_coding(x0, y0, log 2TbWidth, log 2TbHeight, cIdx)). As shown in blocks 1210 and 1220 in the coding syntax table of FIG. 12 with emphasis in bold, grey, or double strike-through, the flags (e.g. coded_sub_block_flags) are coded right after coding of the last significant position.

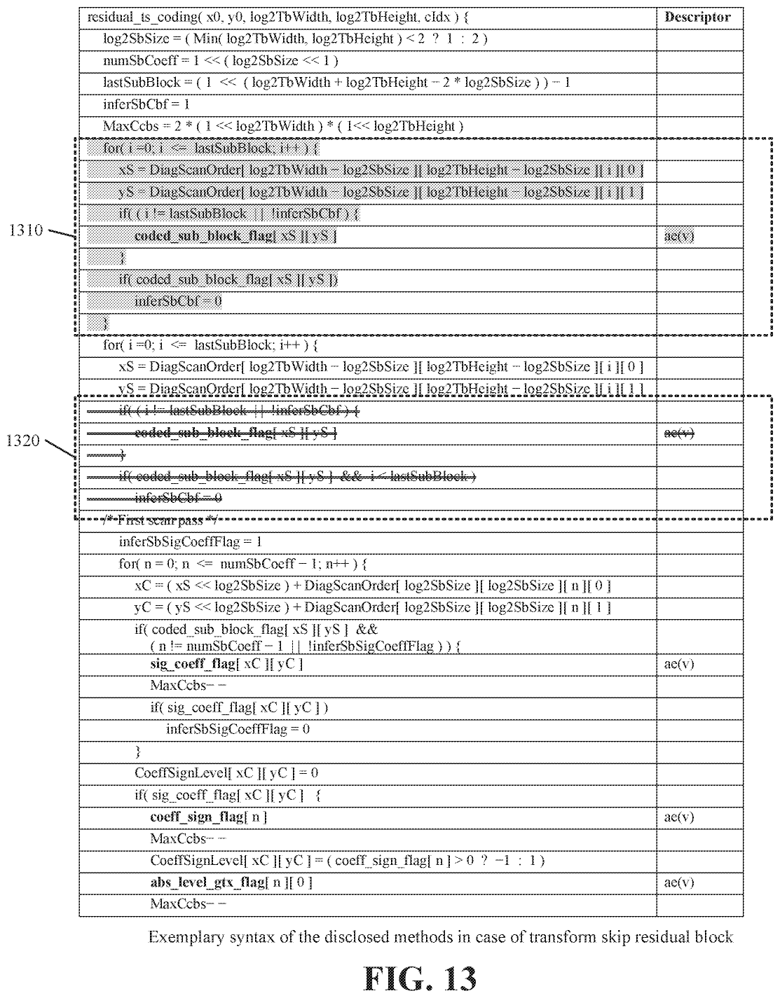

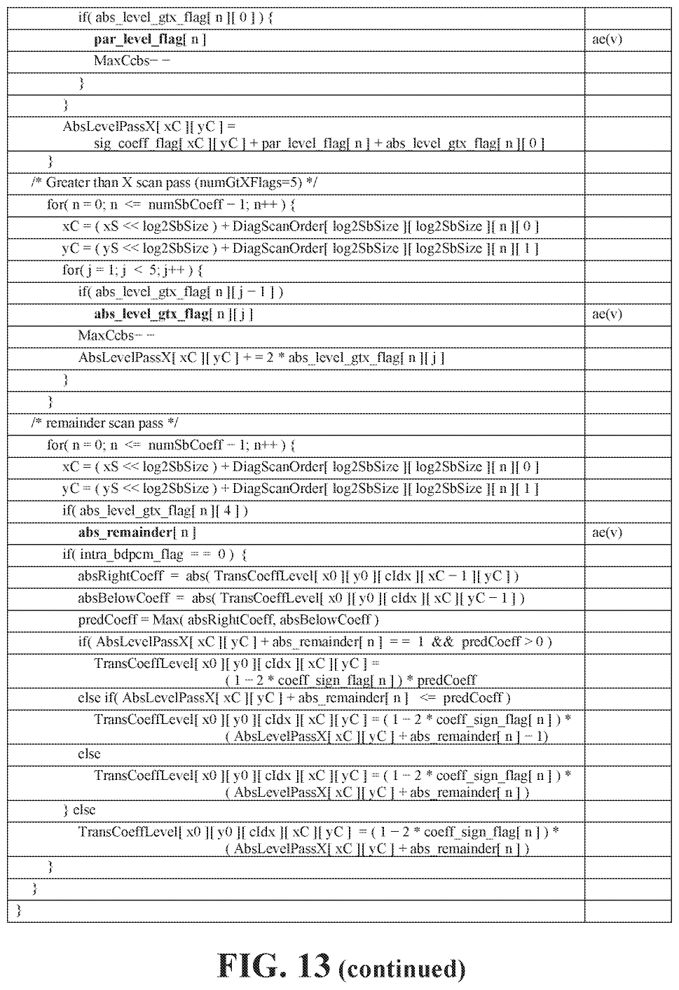

FIG. 13 illustrates an exemplary coding syntax table of the proposed method in case of transform-skip residual block, consistent with some embodiments of the disclosure. Particularly, the table in FIG. 13 shows a residual coding syntax (e.g., residual_ts_coding(x0, y0, log 2TbWidth, log 2TbHeight, cIdx)). As shown in blocks 1310 and 1320 in the coding syntax table of FIG. 13 with emphasis in bold, grey, or double strike-through, the flags (e.g. coded_sub_blockflags) are repositioned at the beginning of the residual block for transform skip case.

The residual_coding( ) syntax structure of FIG. 12 and the residual_ts_coding( ) syntax structure of FIG. 13 can respectively be used to parse the residual samples of a transform block and a transform skip block for the current slice. Particularly, in the syntax structures of FIG. 12 and of FIG. 13, for the subblock at location (xS, yS) within the current transform block, when coded_sub_block_flag [xS][yS] is equal to 0, all transform coefficient levels of the subblock at location (xS, yS) are inferred to be equal to 0. When coded_sub_block_flag [xS][yS] is not present, it is inferred to be equal to 1. For the transform coefficient location (xC, yC) within the current transform block, if sig_coeff_flag [xC][yC] is equal to 0, the transform coefficient level at the location (xC, yC) is set equal to 0. Otherwise (e.g., sig_coeff_flag [xC][yC] being equal to 1), the transform coefficient level at the location (xC, yC) has a non-zero value. At the end of the syntax structure, the transform coefficient levels are represented by the arrays TransCoeffLevel [x0][y0][cIdx][xC][yC]. The array indices x0, y0 specify the location (x0, y0) of the top-left luma sample of the considered transform block relative to the top-left luma sample of the picture. The array index cIdx specifies an indicator for the color component, which is equal to 0 for Y, 1 for Cb, and 2 for Cr. The array indices xC and yC specify the transform coefficient location (xC, yC) within the current transform block.

Similar to the operations at the encoder side, the decoder may also determine the threshold indicating the maximum number of context coded bins for the TB according to the size of the TB. As mentioned above, the threshold can also be defined based on the number of CGs in the TB, which is also the number of flags coded in the bitstream. For example, the threshold can be modified as an original threshold adding an offset value, which is the number of basic processing sub-units in the TB. For example, in some embodiments, if the transform skip flag indicates that the transform stage is skipped in the TB, the threshold can be defined as follows:

MaxCcbs=2*(1<<log 2TbWidth)*(1<<log 2TbHeight)+numSubBlocks,

where log 2TbWidth denotes the logarithmic value of a horizontal width (“TbWidth”) of the TB, log 2TbHeight denotes the logarithmic value of a vertical width (“TbHeight”) of the TB, numSubBlocks denotes the number of CGs in the TB, and MaxCcbs denotes the determined threshold.

On the other hand, in some embodiments, if the transform skip flag indicates that the transform stage is not skipped, the threshold can be defined as follows:

MaxCcbs=((1<<(log 2TbWidth+log 2TbHeight))*7)>>2+numSubBlocks

In view of above, as proposed in various embodiments of the present disclosure, by selecting the context coding mode or the bypass coding mode for encoding and decoding flags and coefficients to or from the bitstream accordingly based on the threshold, the switching between two different coding modes can be reduced in the coding module. In addition, since the encoder and decoder avoid the switching after reaching the upper limit of the context coded bins, the throughput of encoding and decoding can be improved.

Various exemplary embodiments described herein are described in the general context of method steps or processes, which may be implemented in one aspect by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In some embodiments, the computer-readable medium may include a non-transitory computer-readable storage medium, and the computer-executable instructions may be executed by a device (e.g. the disclosed encoder and decoder), for performing the above-described methods. Common forms of non-transitory media include, for example, a floppy disk, a flexible disk, hard disk, solid state drive, magnetic tape, or any other magnetic data storage medium, a compact disc (CD), a digital versatile disc (DVD), or any other optical data storage medium, any physical medium with patterns of holes, a Read Only Memory (ROM), a Random Access Memory (RAM), a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

The embodiments may further be described using the following clauses:
1. A non-transitory computer-readable storage medium storing a set of instructions that are executable by one or more processors of a device to cause the device to perform a method for encoding video, comprising:
coding a bitstream comprising:
a plurality of coefficient groups of a transform block, and
a plurality of flags that correspond respectively to the plurality of coefficient groups,
wherein each of the plurality of coefficient groups comprises one or more coefficients, and
wherein the coding of the bitstream comprises: after a number of context coded bins in the bitstream exceeds a threshold, coding remaining flags or coefficients in the bitstream in a bypass coding mode.
2. The non-transitory computer-readable storage medium of clause 1, wherein the set of instructions that are executable by the one or more processors cause the device to further perform:
signaling the plurality of flags at a beginning of the bitstream, and
the coding the plurality of flags comprises coding one or more of the plurality of flags in a context coding mode.
3. The non-transitory computer-readable storage medium of clause 2, wherein the set of instructions that are executable by the one or more processors cause the device to further perform:
signaling, in the bitstream, the remaining flags coded in the bypass coding mode following one or more flags that are coded in the context coding mode.
4. The non-transitory computer-readable storage medium of clauses 2 or 3, wherein the set of instructions that are executable by the one or more processors cause the device to further perform:
signaling, in the bitstream, the plurality of coefficient groups following the plurality of flags, wherein the coefficients in the plurality of coefficient groups are coded in the context coding mode or in the bypass coding mode.
5. The non-transitory computer-readable storage medium of any of clauses 1-4, wherein in the bypass coding mode, bins are encoded with a fixed probability.
6. The non-transitory computer-readable storage medium of clause 1, wherein each of the plurality of coefficient groups is signaled, in the bitstream, following the corresponding flag.
7. The non-transitory computer-readable storage medium of clause 6, wherein the set of instructions that are executable by the one or more processors cause the device to further perform:
determining, before coding a first flag in the bitstream, whether the number of the context coded bins exceeds the threshold;
in response to the number of the context coded bins being equal to or below the threshold, coding the first flag in the context coding mode; and
in response to the number of the context coded bins exceeding the threshold, coding the first flag in the bypass coding mode.
8. The non-transitory computer-readable storage medium of clauses 6 or 7, wherein the set of instructions that are executable by the one or more processors cause the device to further perform:
in response to the number of the context coded bins of the bitstream exceeds the threshold, coding, in the bypass coding mode, the remaining flags and corresponding coefficients in one or more bypass coded bins.
9. The non-transitory computer-readable storage medium of any of clauses 1-8, wherein the set of instructions that are executable by the one or more processors cause the device to further perform:
determining the threshold according to a size of the transform block.
10. The non-transitory computer-readable storage medium of clause 9, wherein determining the threshold comprises:
determining the threshold according to a number of the plurality of coefficient groups in the transform block.
11. The non-transitory computer-readable storage medium of clause 9 or clause 10, wherein determining the threshold comprises:
determining the threshold according to a number of the plurality of flags in the bitstream.
12. The non-transitory computer-readable storage medium of any of clauses 1-11, wherein each of the plurality of coefficient groups comprises one or more transform residual coefficients, or one or more transform skip residual coefficients.
13. The non-transitory computer-readable storage medium of any of clauses 1-12, wherein each of the plurality of flags indicates whether the corresponding coefficient group includes at least one non-zero coefficient.
14. The non-transitory computer-readable storage medium of any of clauses 1-13, wherein the set of instructions that are executable by the one or more processors cause the device to further perform:
in response to coefficients within a first coefficient group being equal to zero, skipping coding the coefficients within the first coefficient group.
15. The non-transitory computer-readable storage medium of any of clauses 1-14, wherein the threshold indicates a maximum number of the context coded bins of the transform block and depends on whether a transform stage is skipped in the transform block.
16. A non-transitory computer-readable storage medium storing a set of instructions that are executable by one or more processors of a device to cause the device to perform a method for decoding video, comprising:
receiving a bitstream comprising:
   a plurality of coefficient groups of a transform block, and
   a plurality of coded flags that correspond respectively to the plurality of coefficient groups;
decoding the bitstream to obtain one or more residual coefficients, and
reconstructing, based on the residual coefficients, a video stream corresponding to the bitstream,
wherein each of the plurality of coefficient groups comprises one or more coefficients, and
wherein the decoding of the bitstream comprises: after a number of context coded bins exceeds a threshold, decoding remaining flags or coefficients in the bitstream in a bypass decoding mode.
17. The non-transitory computer-readable storage medium of clause 16, wherein the set of instructions that are executable by the one or more processors cause the device to further perform:
receiving the plurality of coded flags at a beginning of the bitstream, and
the decoding the plurality of coded flags comprises decoding one or more of the plurality of coded flags in a context decoding mode.
18. The non-transitory computer-readable storage medium of clause 17, wherein the set of instructions that are executable by the one or more processors cause the device to further perform:
in response to the number of the context coded bins being equal to or smaller than the threshold, decoding, in a context decoding mode, the flags in the bitstream; and
in response to the number of the context coded bins exceeding the threshold, decoding, in the bypass decoding mode, the remaining flags in the bitstream.
19. The non-transitory computer-readable storage medium of clauses 17 or 18, wherein the set of instructions that are executable by the one or more processors cause the device to further perform:
decoding the plurality of coefficient groups after the plurality of flags are decoded, wherein the coefficients in the plurality of coefficient groups are decoded in the context decoding mode or in the bypass decoding mode.
20. The non-transitory computer-readable storage medium of any of clauses 16-19, wherein in the bypass decoding mode, bins are decoded using a fixed probability.
21. The non-transitory computer-readable storage medium of clause 16, wherein each of the plurality of coefficient groups immediately follows, in the bitstream, a corresponding flag.
22. The non-transitory computer-readable storage medium of clause 21, wherein the set of instructions that are executable by the one or more processors cause the device to further perform:
determining, before decoding a first flag in the bitstream, whether the number of the context coded bins exceeds the threshold;
in response to the number of the context coded bins being equal to or below the threshold, decoding the first flag in the context decoding mode: and
in response to the number of the context coded bins exceeding the threshold, decoding the first flag in the bypass decoding mode.
23. The non-transitory computer-readable storage medium of clause 21 or 22, wherein the set of instructions that are executable by the one or more processors cause the device to further perform:
in response to the number of the context coded bins exceeding the threshold, decoding, in the bypass decoding mode, the remaining flags and corresponding coded coefficients in one or more bypass coded bins.
24. The non-transitory computer-readable storage medium of any of clauses 16-23, wherein the set of instructions that are executable by the one or more processors cause the device to further perform:
determining the threshold according to a size of the transform block.
25. The non-transitory computer-readable storage medium of clause 24, wherein determining the threshold comprises:
determining the threshold according to a number of the plurality of coefficient groups in the transform block.
26. The non-transitory computer-readable storage medium of clauses 24 or 25, wherein determining the threshold comprises:
determining the threshold according to a number of the plurality of flags in the bitstream.
27. The non-transitory computer-readable storage medium of any of clauses 16-26, wherein each of the plurality of coefficient groups comprises one or more transform residual coefficients, or one or more transform skip residual coefficients.
28. The non-transitory computer-readable storage medium of any of clauses 16-27, wherein the set of instructions that are executable by the one or more processors cause the device to further perform:
determining whether each of the plurality of coefficient group includes at least one non-zero coefficient, the determining being based on a value of the corresponding flag
29. The non-transitory computer-readable storage medium of any of clauses 16-28, wherein the set of instructions that are executable by the one or more processors cause the device to further perform:
in response to a flag indicating that the coefficients within the corresponding coefficient group are equal to zero, skipping decoding the coefficients within the corresponding coefficient group.
30. The non-transitory computer-readable storage medium of any of clauses 16-29, wherein the threshold indicates a maximum number of the context coded bins of the transform block and depends on whether a transform stage is skipped in the transform block.
31. An apparatus, comprising:
a memory configured to store instructions; and
a processor coupled to the memory and configured to execute the instructions to cause the apparatus to:
code a bitstream comprising:
a plurality of coefficient groups of a transform block, and
a plurality of flags that correspond respectively to the plurality of coefficient groups,
wherein each of the plurality of coefficient groups comprises one or more coefficients, and
wherein the coding of the bitstream comprises: after a number of context coded bins in the bitstream exceeds a threshold, coding one or more remaining flags or coefficients in the bitstream in a bypass coding mode.
32. The apparatus of clause 31, wherein the processor is further configured to execute the instructions to cause the apparatus to:
signal the plurality of flags at a beginning of the bitstream, and
the processor is further configured to execute the instructions to cause the apparatus to code the plurality of flags by coding one or more of the plurality of flags in a context coding mode.
33. The apparatus of clause 32, wherein the processor is further configured to execute the instructions to cause the apparatus to:
signal, in the bitstream, the remaining flags coded in the bypass coding mode following the flags that are coded in a context coding mode.
34. The apparatus of clauses 32 or 33, wherein the processor is further configured to execute the instructions to cause the apparatus to:
signaling, in the bitstream, the plurality of coefficient groups following the plurality of flags in the bitstream, wherein the coefficients in the plurality of coefficient groups are coded in the context coding mode or in the bypass coding mode.
35. The apparatus of any of clauses 31-34, wherein in the bypass coding mode, bins are encoded with a fixed probability.
36. The apparatus of clause 31, wherein each of the plurality of coefficient groups is signaled, in the bitstream, following the corresponding flag.
37. The apparatus of clause 36, wherein the processor is further configured to execute the instructions to cause the apparatus to:
determine, before coding a first flag in the bitstream, whether the number of the context coded bins exceeds the threshold;
in response to the number of the context coded bins being equal to or below the threshold, code the first flag, in the context coding mode; and
in response to the number of the context coded bins exceeding the threshold, code the first flag, in the bypass coding mode.
38. The apparatus of clauses 36 or 37, wherein the processor is further configured to execute the instructions to cause the apparatus to:
in response to the number of the context coded bins of the bitstream exceeds the threshold, code, in the bypass decoding mode, the remaining flags and corresponding coefficients in one or more bypass coded bins.
39. The apparatus of any of clauses 31-38, wherein the processor is further configured to execute the instructions to cause the apparatus to:
determine the threshold according to a size of the transform block.
40. The apparatus of clause 39, wherein the processor is further configured to execute the instructions to cause the apparatus to determine the threshold by:
determining the threshold according to a number of the plurality of coefficient groups in the transform block.
41. The apparatus of clauses 39 or 40, wherein the processor is further configured to execute the instructions to cause the apparatus to determine the threshold by:
determining the threshold according to a number of the plurality of flags in the bitstream.
42. The apparatus of any of clauses 31-41, wherein each of the plurality of coefficient groups comprises one or more transform residual coefficients, or one or more transform skip residual coefficients.
43. The apparatus of any of clauses 31-42, wherein each of the plurality of flags indicates whether the corresponding coefficient group includes at least one non-zero coefficient.
44. The apparatus of any of clauses 31-43, wherein the processor is further configured to execute the instructions to cause the apparatus to:
in response to coefficients within a first coefficient group being equal to zero, skip coding the coefficients within the first coefficient group.
45. The apparatus of any of clauses 31-44, wherein the threshold indicates a maximum number of the context coded bins of the transform block and depends on whether a transform stage is skipped in the transform block.
46. An apparatus, comprising:
a memory configured to store instructions; and
a processor coupled to the memory and configured to execute the instructions to cause the apparatus to:
receive a bitstream comprising:
a plurality of coefficient groups of a transform block, and
a plurality of coded flags that correspond respectively to the plurality of coefficient groups;
decode the bitstream to obtain the coded flags and the coded coefficients in the bitstream to obtain one or more residual coefficients; and
reconstruct, based on the residual coefficients, a video stream corresponding to the bitstream,
wherein each of the plurality of coefficient groups comprises one or more coefficients, and
wherein the decoding of the bitstream comprises: after a number of context coded bins exceeds a threshold, decoding remaining flags or coefficients in the bitstream in a bypass decoding mode.
47. The apparatus of clause 46, wherein the processor is further configured to execute the instructions to cause the apparatus to receiving the plurality of coded flags at a beginning of the bitstream, and to cause the apparatus to decode the plurality of coded flags by decoding one or more of the plurality of coded flags in a context decoding mode.
48. The apparatus of clause 47, wherein the processor is further configured to execute the instructions to cause the apparatus to:
in response to the number of the context coded bins being equal to or smaller than the threshold, decoding, in a context decoding mode, the flags in the bitstream; and
in response to the number of the context coded bins exceeding the threshold, decode, in the bypass decoding mode, the remaining flags in the bitstream.
49. The apparatus of clauses 47 or 48, wherein the processor is further configured to execute the instructions to cause the apparatus to:
decode the plurality of coefficient groups after the plurality of flags are decoded, wherein the coefficients in the plurality of coefficient groups are decoded in the context decoding mode or in the bypass decoding mode.
50. The apparatus of any of clauses 46-49, wherein in the bypass decoding mode, bins are decoded using a fixed probability.
51. The apparatus of clause 46, wherein each of the plurality of coefficient groups immediately follows, in the bitstream, a corresponding flag.
52. The apparatus of clause 51, wherein the processor is further configured to execute the instructions to:
determine, before decoding a first flag in the bitstream, whether the number of the context coded bins exceeds the threshold;
in response to the number of the context coded bins being equal to or below the threshold, decode the first flag in the context decoding mode; and
in response to the number of the context coded bins exceeding the threshold, decode the first flag in the bypass decoding mode.
53. The apparatus of clauses 51 or 52, wherein the processor is further configured to execute the instructions to:
in response to the number of the context coded bins exceeding the threshold, decode, in the bypass decoding mode, the remaining flags and corresponding coded coefficients in one or more bypass coded bins.
54. The apparatus of any of clauses 46-53, wherein the processor is further configured to execute the instructions to:
determine the threshold according to a size of the transform block.
55. The apparatus of clause 54, wherein the processor is further configured to execute the instructions to determine the threshold by:
determining the threshold according to the number of the plurality of coefficient groups in the transform block.
56. The apparatus of clauses 54 or 55, wherein the processor is further configured to execute the instructions to determine the threshold by:
determining the threshold according to the number of the plurality of flags in the bitstream.
57. The apparatus of any of clauses 46-56, wherein each of the plurality of coefficient groups comprises one or more transform residual coefficients, or one or more transform skip residual coefficients.
58. The apparatus of any of clauses 46-57, wherein the processor is further configured to execute the instructions to:
determine whether each of the plurality of coefficient group includes at least one non-zero coefficient, the determining being based on a value of the corresponding coded flag.
59. The apparatus of any of clauses 46-58, wherein the processor is further configured to execute the instructions to cause the apparatus to:
in response to a flag indicating that the coefficients within the corresponding coefficient group are equal to zero, skip decoding the coefficients within the corresponding coefficient group.
60. The apparatus of any of clauses 46-59, wherein the threshold indicates a maximum number of the context coded bins of the transform block and depends on whether a transform stage is skipped in the transform block.
61. A computer-implemented method for encoding video, comprising:
coding a bitstream comprising:
a plurality of coefficient groups of a transform block, and
a plurality of flags that correspond respectively to the plurality of coefficient groups,
wherein each of the plurality of coefficient groups comprises one or more coefficients, and
wherein the coding of the bitstream comprises: after a number of context coded bins in the bitstream exceeds a threshold, coding remaining flags or coefficients in the bitstream in a bypass coding mode.
62. The method of clause 61, further comprising:
signaling the plurality of flags at a beginning of the bitstream,
wherein the coding the plurality of flags comprises coding one or more of the plurality of flags in a context coding mode.
63. The method of clause 62, further comprising:
signaling, in the bitstream, the remaining flags coded in the bypass coding mode following the flags that are coded in a context coding mode.
64. The method of clause 62 or 63, further comprising:
signaling, in the bitstream, the plurality of coefficient groups following the plurality of flags, wherein the coefficients in the plurality of coefficient groups are coded in the context coding mode or in the bypass coding mode.
65. The method of any of clauses 61-64, wherein in the bypass coding mode, bins are encoded with a fixed probability.
66. The method of clause 61, wherein coding the plurality of coefficients comprises:
signaling, in the bitstream, each of the plurality of coefficient groups following the corresponding flag.
67. The method of clause 66, further comprising:
determining, before coding a first flag in the bitstream, whether the number of the context coded bins exceeds the threshold;
in response to the number of the context coded bins being equal to or below the threshold, coding the first flag in the context coding mode; and
in response to the number of the context coded bins exceeding the threshold, coding the first flag in the bypass coding mode.
68. The method of clause 66 or 67, further comprising:
in response to the number of the context coded bins of the bitstream exceeds the threshold, coding, in the bypass decoding mode, the remaining flags and corresponding coefficients in one or more bypass coded bins.
69. The method of any of clauses 61-68, further comprising:
determining the threshold according to a size of the transform block.
70. The method of clause 69, wherein determining the threshold comprises:
determining the threshold according to a number of the plurality of coefficient groups in the transform block.
71. The method of clauses 69 or 70, wherein determining the threshold comprises:
determining the threshold according to a number of the plurality of flags in the bitstream.
72. The method of any of clauses 61-71, wherein each of the plurality of coefficient groups comprises one or more transform residual coefficients, or one or more transform skip residual coefficients.
73. The method of any of clauses 61-72, wherein each of the plurality of flags indicates whether the corresponding coefficient group includes at least one non-zero coefficient.
74. The method of any of clauses 61-73, further comprising:
in response to coefficients within a first coefficient group being equal to zero, skipping coding the coefficients within the first coefficient group.
75. The method of any of clauses 61-74, wherein the threshold indicates a maximum number of the context coded bins of the transform block and depends on whether a transform stage is skipped in the transform block.
76. A computer-implemented method for decoding video, comprising:
receiving a bitstream comprising:
   a plurality of coefficient groups of a transform block, and
a plurality of coded flags that correspond respectively to the plurality of coefficient groups;
decoding the bitstream to obtain one or more residual coefficients; and
reconstructing, based on the residual coefficients, a video stream corresponding to the bitstream,
wherein each of the plurality of coefficient groups comprises one or more coefficients, and
wherein the decoding of the bitstream comprises: after a number of context coded bins exceeds a threshold, decoding remaining flags or coefficients in the bitstream in a bypass decoding mode.
77. The method of clause 76, further comprising:
receiving the plurality of coded flags at a beginning of the bitstream,
wherein the decoding the plurality of coded flags comprises decoding one or more of the plurality of coded flags in a context decoding mode.
78. The method of clause 77, further comprising:
in response to the number of the context coded bins being equal to or smaller than the threshold, decoding, in a context decoding mode, the flags in the bitstream; and
in response to the number of the context coded bins exceeding the threshold, decoding, in the bypass decoding mode, the remaining coded flags in the bitstream.
79. The method of clauses 77 or 78, further comprising:
decoding the plurality of coefficient groups after the plurality of flags are decoded, wherein the coefficients in the plurality of coefficient groups are decoded in the context decoding mode or in the bypass decoding mode.
80. The method of any of clauses 76-79, wherein in the bypass decoding mode, bins are decoded using a fixed probability.
81. The method of clause 76, wherein each of the coefficient groups immediately follows, in the bitstream, by a corresponding flag.
82. The method of clause 81, further comprising:
determining, before decoding a first flag in the bitstream, whether the number of the context coded bins exceeds the threshold;
in response to the number of the context coded bins being equal to or below the threshold, decoding the first flag in the context decoding mode; and
in response to the number of the context coded bins exceeding the threshold, decoding the first flag in the bypass decoding mode.
83. The method of clauses 81 or 82, further comprising:
in response to the number of the context coded bins exceeding the threshold, decoding, in the bypass decoding mode, the remaining flags and corresponding coded coefficients in one or more bypass coded bins.
84. The method of any of clauses 76-83, further comprising:
determining the threshold according to a size of the transform block.
85. The method of clause 84, wherein determining the threshold comprises:
determining the threshold according to a number of the plurality of coefficient groups in the transform block.
86. The method of clauses 84 or 85, wherein determining the threshold comprises:
determining the threshold according to a number of the plurality of flags in the bitstream.
87. The method of any of clauses 76-86, wherein each of the plurality of coefficient groups comprises one or more transform residual coefficients, or one or more transform skip residual coefficients.
88. The method of any of clauses 76-87, further comprising:
determining whether each of the plurality of coefficient group includes at least one non-zero coefficient, the determining being based on a value of the corresponding flag.
89. The method of any of clauses 76-88, further comprising:
in response to a flag indicating that the coefficients within the corresponding coefficient group are equal to zero, skipping decoding the coefficients within the corresponding coefficient group.
90. The method of any of clauses 76-89, wherein the threshold indicates a maximum number of the context coded bins of the transform block and depends on whether a transform stage is skipped in the transform block.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

What is claimed is:

1. A non-transitory computer-readable storage medium storing a set of instructions that are executable by one or more processors of a device to cause the device to perform a method for encoding video, comprising:
coding a bitstream comprising:
a plurality of coefficient groups of a transform block, and
a plurality of flags that correspond respectively to the plurality of coefficient groups,
wherein each of the plurality of coefficient groups comprises one or more coefficients, and
wherein the coding of the bitstream comprises: after a number of context coded bins in the bitstream exceeds a threshold, coding one or more remaining flags or coefficients in the bitstream in a bypass coding mode.

2. The non-transitory computer-readable storage medium of claim 1, wherein the set of instructions that are executable by the one or more processors cause the device to further perform:
signaling the plurality of flags at a beginning of the bitstream, and
the coding the plurality of flags comprises coding one or more of the plurality of flags in a context coding mode.

3. The non-transitory computer-readable storage medium of claim 2, wherein the set of instructions that are executable by the one or more processors cause the device to further perform:
signaling, in the bitstream, the one or more remaining flags coded in the bypass coding mode following the one or more flags that are coded in the context coding mode.

4. The non-transitory computer-readable storage medium of claim 2, wherein the set of instructions that are executable by the one or more processors cause the device to further perform:
signaling, in the bitstream, the plurality of coefficient groups following the plurality of flags, wherein the coefficients in the plurality of coefficient groups are coded in the context coding mode or in the bypass coding mode.

5. The non-transitory computer-readable storage medium of claim 1, wherein each of the plurality of coefficient groups is signaled, in the bitstream, following a corresponding flag.

6. The non-transitory computer-readable storage medium of claim 5, wherein the set of instructions that are executable by the one or more processors cause the device to further perform:
determining, before coding a first flag in the bitstream, whether the number of the context coded bins exceeds the threshold;
in response to the number of the context coded bins being equal to or below the threshold, coding the first flag in a context coding mode; and
in response to the number of the context coded bins exceeding the threshold, coding the first flag in the bypass coding mode.

7. The non-transitory computer-readable storage medium of claim 1, wherein the set of instructions that are executable by the one or more processors cause the device to further perform:
determining the threshold according to a number of the plurality of coefficient groups in the transform block or according to a number of the plurality of flags in the bitstream.

8. An apparatus, comprising:
a memory configured to store instructions; and
a processor coupled to the memory and configured to execute the instructions to cause the apparatus to:
code a bitstream comprising:
a plurality of coefficient groups of a transform block, and
a plurality of flags that correspond respectively to the plurality of coefficient groups,
wherein each of the plurality of coefficient groups comprises one or more coefficients, and
wherein the coding of the bitstream comprises: after a number of context coded bins in the bitstream exceeds a threshold, coding one or more remaining flags or coefficients in the bitstream in a bypass coding mode.

9. The apparatus of claim 8, wherein the processor is further configured to execute the instructions to cause the apparatus to:
signal the plurality of flags at a beginning of the bitstream, and
the processor is further configured to execute the instructions to cause the apparatus to code the plurality of flags by coding one or more of the plurality of flags in a context coding mode.

10. The apparatus of claim 9, wherein the processor is further configured to execute the instructions to cause the apparatus to:
signal, in the bitstream, the one or more remaining flags coded in the bypass coding mode following the one or more flags that are coded in the context coding mode.

11. The apparatus of claim 9, wherein the processor is further configured to execute the instructions to cause the apparatus to:
signaling, in the bitstream, the plurality of coefficient groups following the plurality of flags in the bitstream, wherein the coefficients in the plurality of coefficient groups are coded in the context coding mode or in the bypass coding mode.

12. The apparatus of claim 8, wherein each of the plurality of coefficient groups is signaled, in the bitstream, following a corresponding flag.

13. The apparatus of claim 12, wherein the processor is further configured to execute the instructions to cause the apparatus to:
determine, before coding a first flag in the bitstream, whether the number of the context coded bins exceeds the threshold;
in response to the number of the context coded bins being equal to or below the threshold, code the first flag, in a context coding mode; and
in response to the number of the context coded bins exceeding the threshold, code the first flag, in the bypass coding mode.

14. The apparatus of claim 8, wherein the processor is further configured to execute the instructions to cause the apparatus to:
determine the threshold according to a number of the plurality of coefficient groups in the transform block or according to a number of the plurality of flags in the bitstream.

15. A computer-implemented method for encoding video, comprising:
coding a bitstream comprising:
a plurality of coefficient groups of a transform block, and
a plurality of flags that correspond respectively to the plurality of coefficient groups,
wherein each of the plurality of coefficient groups comprises one or more coefficients, and
wherein the coding of the bitstream comprises: after a number of context coded bins in the bitstream exceeds a threshold, coding one or more remaining flags or coefficients in the bitstream in a bypass coding mode.

16. The method of claim 15, further comprising:
signaling the plurality of flags at a beginning of the bitstream,
wherein the coding the plurality of flags comprises coding one or more of the plurality of flags in a context coding mode.

17. The method of claim 16, further comprising:
signaling, in the bitstream, the one or more remaining flags coded in the bypass coding mode following the one or more flags that are coded in the context coding mode.

18. The method of claim 16, further comprising:
signaling, in the bitstream, the plurality of coefficient groups following the plurality of flags, wherein the coefficients in the plurality of coefficient groups are coded in the context coding mode or in the bypass coding mode.

19. The method of claim 15, wherein coding the plurality of coefficients comprises:
signaling, in the bitstream, each of the plurality of coefficient groups following a corresponding flag.

20. The method of claim 19, further comprising:
determining, before coding a first flag in the bitstream, whether the number of the context coded bins exceeds the threshold;
in response to the number of the context coded bins being equal to or below the threshold, coding the first flag in a context coding mode; and
in response to the number of the context coded bins exceeding the threshold, coding the first flag in the bypass coding mode.
